(19) United States
(12) Patent Application Publication
(10) Pub. No.: US 2005/0047701 A1
(43) Pub. Date: Mar. 3, 2005

(54) Thrust bearing assembly for a cam locking assembly

(75) Inventors: Gary T. Schick, Goshen, CT (US); Glenn DiCostanzo, Litchfield, CT (US); Walter Richard Gist JR., Bristol, CT (US)

Correspondence Address: MICHAEL BEST & FRIEDRICH LLP, 3773 CORPORATE PARKWAY, SUITE 360, CENTER VALLEY, PA, 18034-8217, US

(73) Assignee: Timken US Corporation, Torrington, CT (US)

(21) Appl. No.: 10/650,324

(22) Filed: Aug. 28, 2003

(51) Int. Cl. F16C 33/46

(52) U.S. Cl. 384/623

(57) ABSTRACT

A thrust bearing assembly comprising a retainer cage and a plurality of rollers positioned in roller retaining pockets spaced about the retainer cage. At least one of the pockets is an angled pocket having a radial axis that is non-parallel relative to a retainer cage centerline passing through the angled pocket.

### BACKGROUND

The present invention relates to cam lock assemblies. More particularly, the present invention relates to a thrust bearing assembly for use with cam locking assemblies.

Many applications utilize a cam lock assembly to releasably lock two or more components relative to one another. The cam lock assemblies generally comprise two opposed plates rotatable relative to one another. At least one of the plates has a cam surface such that as the plates are rotated relative to one another in a first direction, the plates move away from each other to cause a friction lock and when rotated in the opposite direction, move toward one another to release the friction lock. Examples of applications utilizing such assemblies include adjustable steering column assemblies and parking break levers. Cam locking assemblies can be utilized in many other applications as well.

Cam locking assemblies require sufficient friction between the components to ensure reliable locking. In some assemblies however, release of the friction between the lock components results in a sudden relative movement, or snap-back, of the components. Snap-back is generally an undesireable condition in the cam locking applications.

### SUMMARY

The present invention provides a thrust bearing assembly comprising a retainer cage and a plurality of rollers positioned in roller retaining pockets spaced about the retainer cage. At least one of the pockets is an angled pocket having a radial axis that is non-parallel relative to a retainer cage centerline passing through the angled pocket. The thrust bearing assembly is associated with a cam locking assembly that is rotatable in a locking direction and an unlocking position. The angled pocket causes the rollers to skew, with a resultant drag force, at least when the cam locking assembly is rotated in the unlocking direction. The drag force created as the cam locking assembly is moved in the unlocking direction counter balances the snap-back force.

### BRIEF DESCRIPTION OF THE DRAWINGS

FIG. 1 is a cross-sectional elevational view of an illustrative steering column assembly with a cam locking assembly incorporating a thrust bearing assembly in accordance with the present invention.

FIG. 2 is a front elevational view of a thrust bearing cage in accordance with a first embodiment of the present invention.

FIG. 3 is a partial front elevational view of the thrust bearing assembly of the first embodiment as the cam locking assembly is rotated in a first direction.

FIG. 4 is a partial front elevational view of the thrust bearing assembly of the first embodiment as the cam locking assembly is rotated in a second direction.

FIG. 5 is a front elevational view of a thrust bearing cage in accordance with a second embodiment of the present invention.

FIG. 6 is a partial front elevational view of the thrust bearing assembly of the second embodiment as the cam locking assembly is rotated in the unlocking direction.

FIG. 7 is a partial front elevational view of the thrust bearing assembly of the second embodiment as the cam locking assembly is rotated in the locking direction.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

Referring to FIG. 1, a first embodiment of a cam locking assembly 10 in accordance with a first embodiment of the present invention is shown in use with an illustrative steering column assembly 100. The cam locking assembly 10 generally includes a tie bolt 12, a thrust bearing assembly 50, a lever member 20 and a caming unit 30. A retainer clip 46 or the like may be provided to unitize the cam locking assembly 10, but such is not required. The tie bolt 12 terminates in a retaining plate 14 at one end and an is generally free at the opposite end 15. The free end 15 is configured for securement relative to a steering column assembly 100.

The lever unit 20 preferably includes an extending handle 22 connected to a plate 24. The plate 24 has an aperture 26 therethrough configured to receive the tie bolt 12 such that the plate 24 may be rotated thereabout or rotated therewith. The illustrated bearing assembly 50 is positioned between the handle plate 24 and the retaining plate 14 to help facilitate rotation of the handle unit 20. However, the bearing assembly 50 may be otherwise positioned to assist rotation. For example, if the tie bolt 14 rotates with the lever unit 20, the thrust bearing assembly 50 may be located on the nut side of the tie bolt 14. The bearing assembly 50 will be described in more detail hereinafter.

The caming unit 30 generally comprises a pair of opposed cam plates 32 and 34 with a roller assembly 40 positioned therebetween. The roller assembly 40 includes a plurality of rollers 44 maintained in a retainer plate 42. At least one of the cam plates 32, 34 has a surface with a plurality cam ramps configured to receive the rollers 44. Cam plate 32 is interconnected to the lever plate 24 such that cam plate 32 rotates in conjunction with the rotation of the lever plate 24. Plate 34 is interconnected to the column mounting arm 102 to prevent rotation of the plate 34. As such, as the lever unit 20 is rotated, plates 32, 34 are rotated relative to one another.

The cam locking assembly 10 is positioned with the tie bolt 12 passed through the opposed brackets 102 of the steering column assembly 100. The tie bolt 12 is then secured. Rotation of the handle 22 causes rotation of cam plate 32 between a lock position wherein the rollers 44 move up the cam ramps to push the plates 32 and 34 apart, thereby applying pressure to the opposed brackets 102, and an open position wherein the rollers 44 move down the cam ramps such that the pressure is relieved.

As indicated above, the steering column assembly 100 is utilized for illustrative purposes only. Additionally, the cam locking assembly 10 can have varying configurations. For example, different tie bolts 12, lever units 20, and caming assemblies 30 may be utilized.

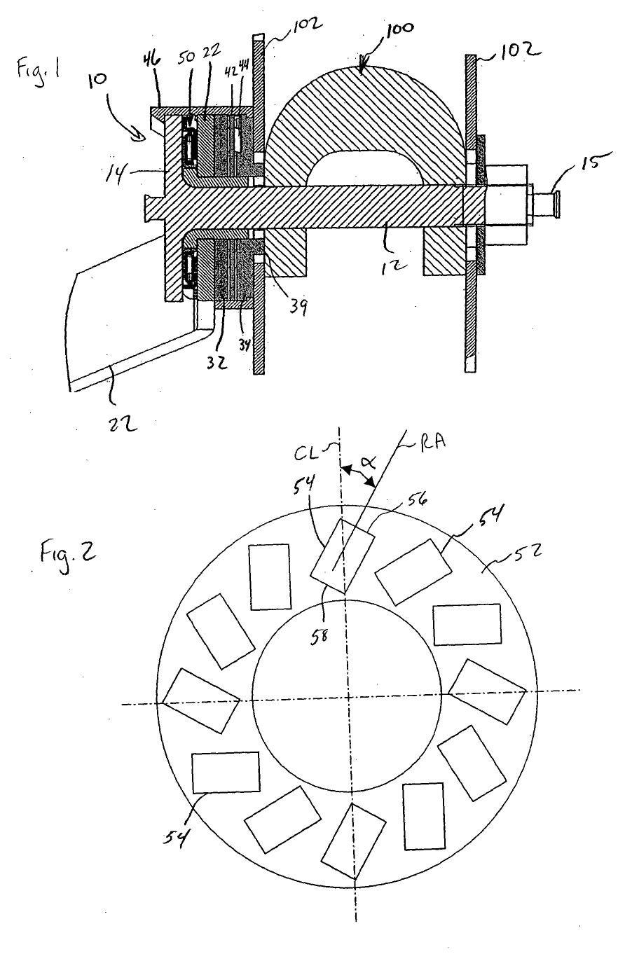

A first embodiment of the bearing assembly 50 will be described with reference to FIGS. 2-4. The bearing assembly 50 generally comprises a cage 52 with a plurality of rollers 60 maintained in pockets 54 in the cage 52. The cage 52 is illustrated as planar surface, but the cage 52 can have various configurations. The cage 52 may be a single member or a multi-piece member, for example, a two-piece, snapped together unit. The cage 52 can be planar, or may have a non-planar configuration, for example a sigma retainer. The cage 52 may include protrusions or the like (not shown) into the pockets 54 to retain the rollers 60 therein, however, such is not required. The cage 52 may be manufactured from various materials, including metals, polymers and other natural and synthetic materials. Inner and outer raceways (not shown) may be provided about the cage 52, for example to unitize the assembly, but such is not required. The rollers 60 may bear directly on the handle plate 24 and the retaining plate 14.

Referring to FIG. 2, each pocket 54 has a radial axis RA that is at an angle α relative to the radial cage centerline CL extending through the pocket 54. Preferably, the pockets 54 are angled such that the outer radial pocket edge 56 trails the inner radial pocket edge 58 as the cam locking assembly 10 is rotated in the first direction as indicated by the arrow A in FIG. 3. As such, as the cam locking assembly 10 is rotated in this direction indicted by arrow A, the rollers 60 attempt to roll in an inward, downward (relative to the position shown in FIG. 3) direction, as indicated by arrow B, while the angled pocket 54 drive the rollers 60 in an outward, upward direction, as indicated by arrow C. As a result, the rollers 60 are skewed within the pockets 54 and do not roll freely, but instead are subjected to a drag force.

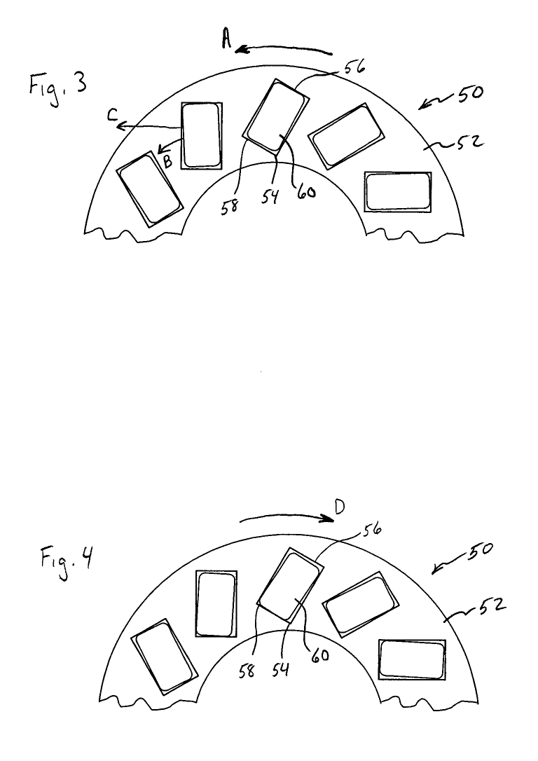

Similarly, when the cam locking assembly 10 is rotated in the second direction, as indicated by arrow D in FIG. 4, the angle of the pockets 54 is such that the outer radial pocket edge 56 is forward the inner radial pocket edge 58. As a result, the pockets 54 drive the rollers 60 in an inward, downward manner, distinct from the path the rollers 60 attempt to travel. As a result, the rollers 60 are skewed with a resultant drag force. The amount of drag force is preferably controlled such that the drag force counters the snap-back force, thereby providing a smoother unlocking of the cam locking assembly 10. The amount of drag force in the locking direction is preferably also controlled such that an excessive force is not required to lock the cam locking assembly 10.

The amount of drag force can be controlled in various ways. For example, the angle α can be adjusted to change the amount of drag force. In the illustrated embodiment, each of the pockets 54 has a radial axis RA that is at angle α of approximately 30° with respect to the respective radial cage centerline CL extending through the pocket 54. However, the angle can be increased to increase the drag force, or decreased to decrease the drag force. Additionally, the number and positioning of the pockets 54 can also be varied to achieve different values of drag force. In the illustrated embodiment, each of the pockets 54 is angled, however, it is possible to angle less than all of the pockets 54, for example, every other pocket, to reduce the amount of drag. The material choosen for the cage 52 may also be varied to achieve different drag forces. Additionally, the relative size of the pockets 54 and rollers 60 may be adjusted to vary the drag force. The direction in which the pockets 54 are angled relative to the direction of travel may also effect the drag force. For example, in some applications the angle in FIG. 3, away from the direction of travel, may cause more drag than that in FIG. 4. In such applications, it is desiraeble to have the first direction of rotation shown in FIG. 3 be the unlocking direction such that the greater drag force counters the snap-back force. The above are illustrative variables, but are not intended to be limiting.

A thrust bearing assembly 150 that is a second embodiment of the present invention is illustrated in FIGS. 5-7. The thrust bearing assembly 150 is similar to the thrust bearing assembly 50 of the previous embodiment and includes a cage 152 with a plurality of rollers 60 retained in spaced apart pockets 154. As in the previous embodiment, one or more of the pockets 154 has a radial axis RA that is at an angle α relative to the radial cage centerline CL extending through the pocket 154. The pockets 154 are distinct in that the outer radial pocket edge 156 includes opposed inwardly tapered sides 162. The tapered sides 162 narrow the pocket 154 adjacent the outer radial edge 156.

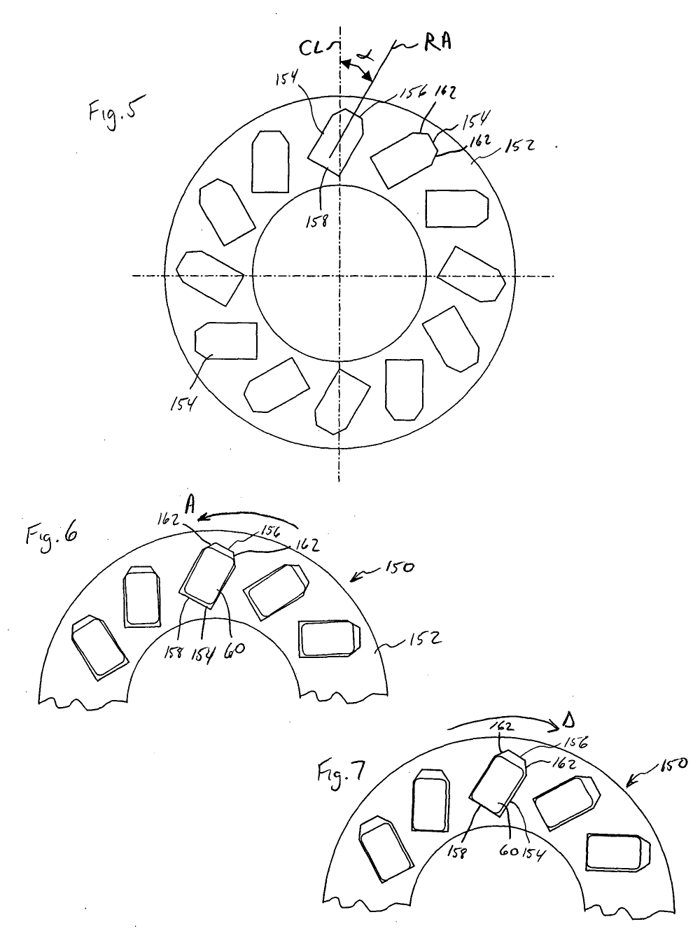

In this embodiment, the pockets 154 are preferably angled such that the outer radial pocket edge 156 trails the inner radial pocket edge 158 as the cam locking assembly 10 is rotated in the unlocking direction as indicated by the arrow A in FIG. 6. As such, as the cam locking assembly 10 is rotated in the unlocking direction indicted by arrow A, the angled pockets 154 drive the rollers 60 in an outward, upward direction, against the rollers 60 desired path. Additionally, the outward force causes the rollers 60 to move outward toward the narrow outer radial edge 156 and in to contact with the tapered sides 162. As a result, in addition to skewing of the rollers 60 within the pockets 154, the rollers 60 are also subject to direct friction from the tapered sides 162. The drag force and friction force counter the snap-back force, thereby providing a smoother unlocking of the cam locking assembly 10. As in the previous embodiment, the amount of drag force can be controlled in various ways, including modifying the size, position and angle of the tapered sides 162.

When the cam locking assembly 10 is located in the locking direction, as indicated by arrow D in FIG. 7, the angle of the pockets 154 drivea the rollers 60 in an inward, downward manner such that the rollers 60 move away from the tapered sides 162 and roll relatively freely with minimal drag or friction force, thereby allowing smooth locking of the cam locking assembly 10.

1. A thrust bearing assembly comprising:
a retainer cage;
a plurality of roller retaining pockets spaced about the retainer cage, at least one of the pockets being an angled pocket having a radial axis that is non-parallel relative to a retainer cage centerline passing through the angled pocket;
a plurality of rollers positioned in respective pockets.

2. The thrust bearing assembly of claim 1 wherein each roller retaining pocket is an angled pocket.

3. The thrust bearing assembly of claim 1 wherein a roller is positioned in each roller retaining pocket.

4. The thrust bearing assembly of claim 1 wherein the angled pocket radial axis is at an angle of approximately 30° relative to the retainer cage centerline passing through the angled pocket.

5. The thrust bearing assembly of claim 1 wherein the angled pocket radial axis is at an angle between 15° and 30° relative to the retainer cage centerline passing through the angled pocket.

6. The thrust bearing assembly of claim 1 wherein the angled pocket radial axis is at an angle between 30° and 45° relative to the retainer cage centerline passing through the angled pocket.

7. The thrust bearing assembly of claim 1 wherein the retainer cage includes two opposed interconnected members with the roller retaining pockets extending through both members.

8. The thrust bearing assembly of claim 1 wherein the retainer cage has a sigma configuration.

9. The thrust bearing assembly of claim 1 wherein the thrust bearing assembly is associated with a cam locking assembly that is rotatable in a locking direction and an unlocking direction and the angled pocket has an inner radial edge and an outer radial edge, the angled pocket being angled such that the inner radial edge trails in the outer radial edge as the cam locking assembly is rotated in the unlocking direction.

10. The thrust bearing assembly of claim 1 wherein the thrust bearing assembly is associated with a cam locking assembly that is rotatable in a locking direction and an unlocking direction and the angled pocket has an inner radial edge and an outer radial edge, the angled pocket being angled such that the outer radial edge trails in the inner radial edge as the cam locking assembly is rotated in the unlocking direction.

11. The thrust bearing assembly of claim 10 wherein the angled pocket is narrow adjacent the outer radial edge than adjacent the inner radial edge.

12. The thrust bearing assembly of claim 11 wherein the angled pocket has at least one tapered side adjacent the outer radial edge.

13. The thrust bearing assembly of claim 12 wherein the angled pocket has opposed tapered sides adjacent the outer radial edge to define a tapered area adjacent the outer radial edge.

14. The thrust bearing assembly of claim 13 wherein the roller positioned in the angled pocket has a radial length less than the distance between the angled pocket inner radial edge and the tapered area.

15. The thrust bearing assembly of claim 11 wherein the roller moves in to the tapered area as the cam locking assembly is rotated in the unlocking direction such that the angled pocket causes a friction force on the roller.

16. The thrust bearing assembly of claim 15 wherein the cam locking assembly experiences a snap-back force as the cam locking assembly is rotated in the unlocking direction and wherein the at least one angled pocket causes a drag force on the respective roller, the drag force and friction force counter-balancing the snap-back force.

17. The thrust bearing assembly of claim 1 wherein the thrust bearing assembly is associated with a cam locking assembly that is rotatable in a locking direction and an unlocking direction, the cam locking assembly experiencing a snap-back force as the cam locking assembly is rotated in the unlocking direction and wherein the at least one angled pocket causes a drag force on the respective roller that counter-balances the snap-back force.
